(19) United States
(12) Patent Application Publication
(10) Pub. No.: US 2025/0372053 A1
(43) Pub. Date: Dec. 4, 2025

(54) METHOD AND ELECTRONIC DEVICE FOR APPLYING LOCAL DIMMING ON BOOT DISPLAY

(71) Applicant: MediaTek Singapore Pte. Ltd., Singapore (SG)

(72) Inventors: Jiangang LI, Shenzhen (CN); Lin YI, Shenzhen (CN)

(21) Appl. No.: 19/009,250

(22) Filed: Jan. 3, 2025

(30) Foreign Application Priority Data
May 31, 2024 (CN) 202410702670.1

(51) Int. Cl. G09G 3/34

(52) U.S. Cl. CPC G09G 3/3426; G09G 2320/0247; G09G 2320/062; G09G 2320/0686; G09G 2330/026; G09G 2360/16

(57) ABSTRACT

A method for applying local dimming on a boot display is provided. The method includes the following steps. Local dimming data are received during the initialization procedure. The local dimming data are sent to a backlight driver during an Mboot program to enter the initialization procedure. Backlights are turned on based on the local dimming data during the initialization procedure.

### CROSS REFERENCE TO RELATED APPLICATIONS

This application claims the benefit of China Application No. 202410702670.1, filed on May 31, 2024, the entirety of which is incorporated by reference herein.

### FIELD OF THE INVENTION

The present invention relates to backlight applications, and, in particular, to a method and an electronic device for applying local dimming on a boot display.

### DESCRIPTION OF THE RELATED ART

When a display device is turned on, we usually encounter the problem of backlight light leakage. In theory, a panel that supports local dimming can avoid light leakage when displaying a startup logo. However, in the actual finished product, since backlight data are not obtained until the Kernel program is executed, it is too late to send local backlight data to a backlight driver.

At the same time, various phenomena may be encountered such as flickering when the backlight state is switched, and an ideal OLED-like effect is not achieved. The traditional solution is to turn on the global backlight, play a picture with the manufacturer's logo on a bright background, and use the bright background to start the logo. To avoid the poor look and feel of backlight leakage, the procedure waits until the local dimming hardware inside the SoC actually starts working and then displays a picture of the logo with a pure black background to tell the user that this is a display device with a local dimming function. While this can prevent backlight leakage, in fact, this switching between bright and dark background images will make the user feel that the boot process is not smooth and natural.

### BRIEF SUMMARY OF THE INVENTION

An embodiment of the present invention provides a method for applying local dimming on a boot display. The method includes the following steps. Local dimming data are received during the initialization procedure. The local dimming data are sent to a backlight driver during an Mboot program to enter the initialization procedure. Backlights are turned on based on the local dimming data during the initialization procedure.

According to the method described above, the local dimming data is read from a storage device or calculated based on an input image.

According to the method described above, the local dimming data include local dimming backlight duty.

According to the method described above, the step of receiving local dimming data during the initialization procedure includes the following steps. The local dimming data are calculated offline based on the input image used during the previous boot-up. The local dimming data are stored in storage during the previous boot-up. The local dimming data are read from storage during the initialization procedure.

According to the method described above, the step of receiving local dimming data during the initialization procedure includes the following steps. The local dimming data are on-line calculated based on the input image used during the previous boot-up. The local dimming data are stored in storage during the previous boot-up. The local dimming data are read from storage during the initialization procedure.

According to the method described above, the step of on-line calculating the local dimming data based on the input image used during the previous boot-up is executed by software or hardware.

According to the method described above, the step of receiving local dimming data during the initialization procedure includes the following steps. Software for local dimming is initialized during the initialization procedure. The local dimming data are calculated based on the input image used by the software during the initialization procedure.

According to the method described above, the step of receiving local dimming data during the initialization procedure includes the following steps. Hardware for local dimming is initialized during the initialization procedure. The local dimming data are calculated based on the input image used by the hardware during the initialization procedure.

According to the method described above, the step of on-line calculating the local dimming data based on the input image used during the previous boot-up includes the following steps. An Mboot program is executed to enter the initialization procedure during the previous boot-up. The local dimming data are on-line calculated based on the input image in the initialization procedure during the previous boot-up.

According to the method described above, the step of on-line calculating the local dimming data based on the input image used during the previous boot-up includes the following steps. A Kernel program is executed to enter a main procedure during the previous boot-up. The local dimming data are on-line calculated based on the input image used in the main procedure during the previous boot-up.

An embodiment of the present invention also provides an electronic device to apply local dimming on a boot display. The electronic device includes a backlight driver and a processor. The processor is electrically connected to the backlight driver. The processor receives local dimming data during the initialization procedure, and sends the local dimming data to the backlight driver during an Mboot program to enter the initialization procedure. The backlight driver turns on backlights based on the local dimming data during the initialization procedure.

The electronic device further includes a microcontroller. The microcontroller is electrically connected between the backlight driver and the processor. The microcontroller receives the local dimming data during the initialization procedure, and sends the local dimming data to the backlight driver during the Mboot program to enter the initialization procedure.

According to the electronic device described above, the local dimming data is read from a storage device or calculated based on an input image.

According to the electronic device described above, the local dimming data include local dimming backlight duty.

According to the electronic device described above, the processor off-line calculates the local dimming data based on the input image used during the previous boot-up. The processor stores the local dimming data in storage during the previous boot-up. The processor reads the local dimming data from storage during the initialization procedure.

According to the electronic device described above, the processor on-line calculates the local dimming data based on the input image used during the previous boot-up. The processor stores the local dimming data in storage during the previous boot-up. The processor reads the local dimming data from storage during the initialization procedure.

According to the electronic device described above, the local dimming data are calculated by software or hardware configured by the processor.

According to the electronic device described above, the software for local dimming is initialized during the initialization procedure. The local dimming data are calculated based on the input image used by the software during the initialization procedure.

According to the electronic device described above, the hardware for local dimming is initialized during the initialization procedure. The local dimming data are calculated based on the input image used by the hardware during the initialization procedure.

According to the electronic device described above, the processor executes an Mboot program to enter the initialization procedure during the previous boot-up. The processor on-line calculates the local dimming data based on the input image in the initialization procedure during the previous boot-up.

According to the electronic device described above, the processor executes a Kernel program to enter a main procedure during the previous boot-up. The processor on-line calculates the local dimming data based on the input image used in the main procedure during the previous boot-up.

According to the electronic device described above, the backlight driver includes a plurality of backlight driving integrated circuits (ICs). The number of backlight driving ICs is equal to the number of backlight partitions.

### BRIEF DESCRIPTION OF THE DRAWINGS

The present invention can be more fully understood by reading the subsequent detailed description and examples with references made to the accompanying drawings, wherein:

FIG. 1 is a flow chart of a method for applying local dimming on a boot display in accordance with some embodiments of the present invention.

FIG. 2 is a detail flow chart of a step S102 in FIG. 1 in accordance with some embodiments of the present invention.

FIG. 3 is a detail flow chart of the step S102 in FIG. 1 in accordance with some embodiments of the present invention.

FIG. 4 is a detail flow chart of the step S102 in FIG. 1 in accordance with some embodiments of the present invention.

FIG. 5 is a detail flow chart of the step S102 in FIG. 1 in accordance with some embodiments of the present invention.

FIG. 6 is a detail flow chart of a step S300 in FIG. 3 in accordance with some embodiments of the present invention.

FIG. 7 is a detail flow chart of the step S300 in FIG. 3 in accordance with some embodiments of the present invention.

FIG. 8 is a schematic diagram of an electronic device 800 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

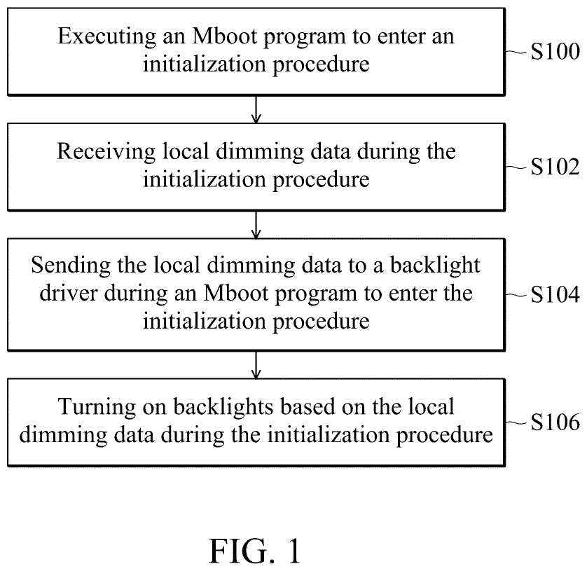

FIG. 1 is a flow chart of a method for applying local dimming on a boot display in accordance with some embodiments of the present invention. As shown in FIG. 1, the method for applying local dimming on a boot display of the present invention includes the following steps. An Mboot program is executed to enter the initialization procedure (step S100). Local dimming data are received during the Mboot program to enter the initialization procedure (step S102). The local dimming data are sent to a backlight driver during the initialization procedure (step S104). Backlights are turned on based on the local dimming data during the initialization procedure (step S106). In some embodiments, the method for applying local dimming on a boot display is applied to an electronic device, such as a laptop, a tablet, or a smart phone, but the present invention is not limited thereto. Since the local dimming data are sent to the backlight driver during the initialization procedure, the flickering when the backlight state is switched can be overcome.

When the electronic device is turned on to enter a booting procedure, the Mboot program may first be executed to enter the initialization procedure in step S100. In some embodiments, the local dimming data are calculated by a processor included in the electronic device. The processor may be a system-on-chip (SoC) or a microcontroller, but the present invention is not limited thereto. In some embodiments, the local dimming data may include local dimming backlight duty. The local dimming backlight duty may determine the real brightness of LEDs in each backlight partition. In some embodiments, the local dimming data is read from a storage device or calculated based on an input image.

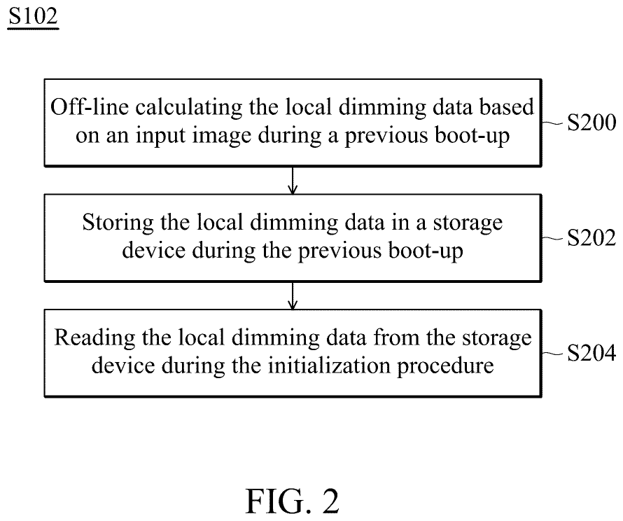

FIG. 2 is a detail flow chart of a step S102 in FIG. 1 in accordance with some embodiments of the present invention. As shown in FIG. 2, step S102 in FIG. 1 includes the following steps. The local dimming data are calculated offline based on the input image used during the previous boot-up (step S200). The local dimming data are stored in storage during the previous boot-up (step S202). The local dimming data are read from storage during the initialization procedure (step 204).

In some embodiments of step 200, the local dimming data are calculated by third-party software executed by another electronic device or the electronic device of the present invention based on the same input image. In some embodiments of step 200, the local dimming data are calculated by hardware of another electronic device based on the same input. After the local dimming data are calculated, the local dimming data may be transmitted to the electronic device of the present invention, so that step S202 of the present invention is performed. In some embodiments, the storage in step S202 is a non-volatile memory. In step S304, when the electronic device is turned on again, the local dimming data have been stored in storage, the local dimming data can directly be read from storage during the initialization procedure.

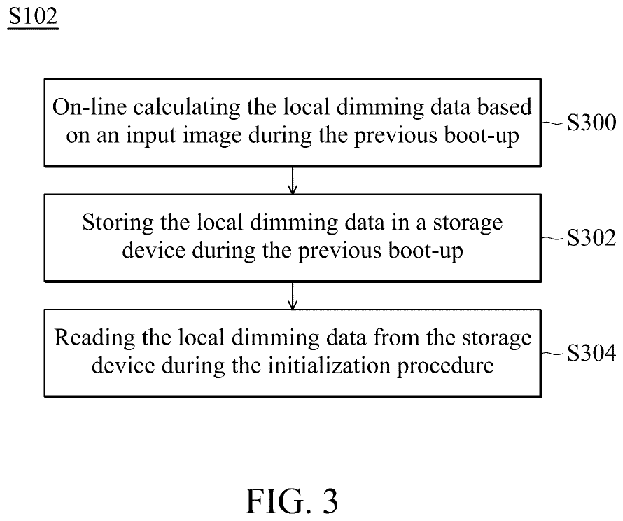

FIG. 3 is a detail flow chart of the step S102 in FIG. 1 in accordance with some embodiments of the present invention. As shown in FIG. 3, step S102 in FIG. 1 includes the following steps. The local dimming data are on-line calculated based on the input image used during the previous boot-up (step S300). The local dimming data are stored in storage during the previous boot-up (step S302). The local dimming data are read from storage during the initialization procedure (step S304). In some embodiments of step S300, the local dimming data are calculated by software or hardware in the electronic device of the present invention based on the same input image used during the previous boot-up. In some embodiments, the storage in step S302 is a non-volatile memory. In step S304, when the electronic device is turned on again, the local dimming data have been stored in storage, the local dimming data can directly be read from storage during the initialization procedure.

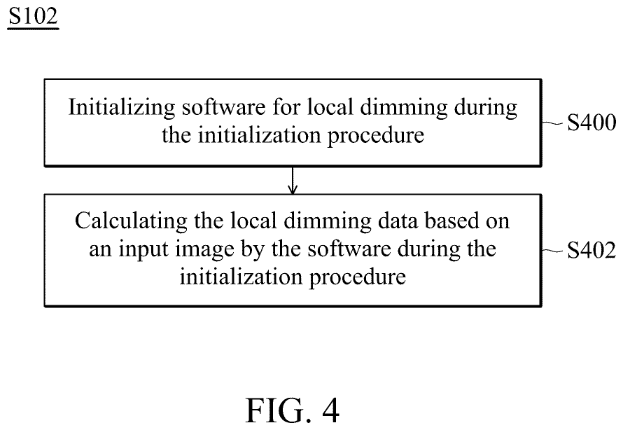

FIG. 4 is a detail flow chart of the step S102 in FIG. 1 in accordance with some embodiments of the present invention. As shown in FIG. 4, step S102 in FIG. 1 includes the following steps. Software for local dimming is initialized during the initialization procedure (step S400). The local dimming data are calculated based on the input image used by the software during the initialization procedure (step S402). In step S400, when the electronic device is turned on to enter a booting procedure, the Mboot program may first be executed to enter the initialization procedure. The software for local dimming outputs the local dimming data based on colors, outlines, and backgrounds in the input image, but the present invention is not limited thereto. After the local dimming data are calculated, it is not necessary to store the local dimming data in storage, but the local dimming data are directly sent to the backlight driver.

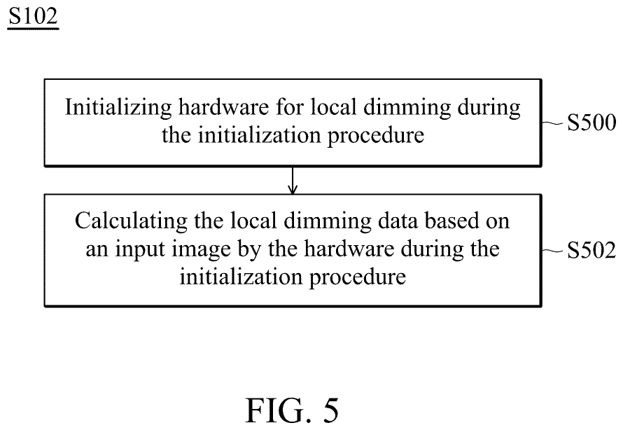

FIG. 5 is a detail flow chart of the step S102 in FIG. 1 in accordance with some embodiments of the present invention. As shown in FIG. 5, step S102 in FIG. 1 includes the following steps. Hardware for local dimming is initialized during the initialization procedure (step S500). The local dimming data are calculated based on the input image used by the hardware during the initialization procedure (step S502). In step S500, when the electronic device is turned on to enter a booting procedure, the Mboot program may first be executed to enter the initialization procedure. The hardware for local dimming outputs the local dimming data based on colors, outlines, and backgrounds in the input image, but the present invention is not limited thereto. After the local dimming data are calculated, it is not necessary to store the local dimming data in storage, but the local dimming data are directly sent to the backlight driver. In some embodiments, the hardware may be a processor, a microcontroller, or a programmable logic controller (PLC), but the present invention is not limited thereto.

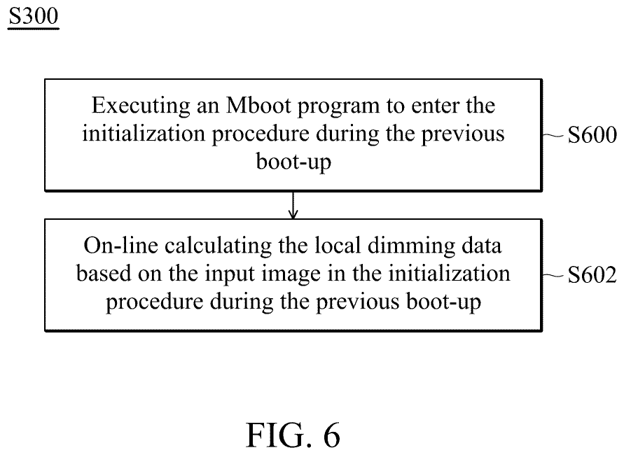

FIG. 6 is a detail flow chart of a step S300 in FIG. 3 in accordance with some embodiments of the present invention. As shown in FIG. 6, step S300 in FIG. 3 includes the following steps. An Mboot program is executed to enter the initialization procedure during the previous boot-up (step S600). The local dimming data are on-line calculated based on the input image in the initialization procedure during the previous boot-up (step S602). In some embodiments, the Mboot program may include codes for the processor to calculate the local dimming data. After the local dimming data are calculated, the local dimming data are then stored into storage for use in the next boot-up.

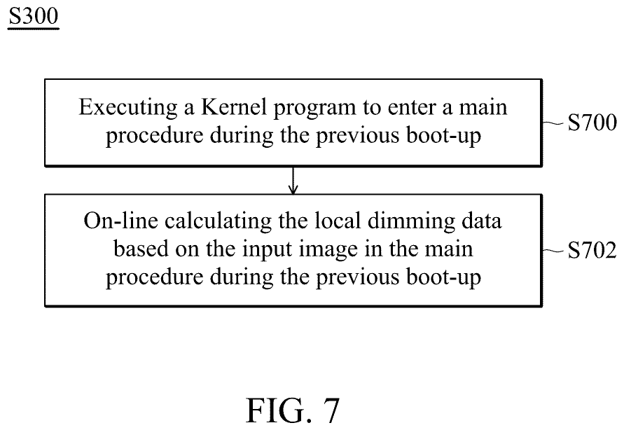

FIG. 7 is a detail flow chart of the step S300 in FIG. 3 in accordance with some embodiments of the present invention. As shown in FIG. 7, step S300 in FIG. 3 includes the following steps. A Kernel program is executed to enter a main procedure during the previous boot-up (step S700). The local dimming data are on-line calculated based on the input image used in the main procedure during the previous boot-up (step S702). In some embodiments, the Kernel program is executed after the Mboot program is completed. The Kernel program may include codes for the processor to calculate the local dimming data. After the local dimming data are calculated, the local dimming data are then stored into storage for use in the next boot-up.

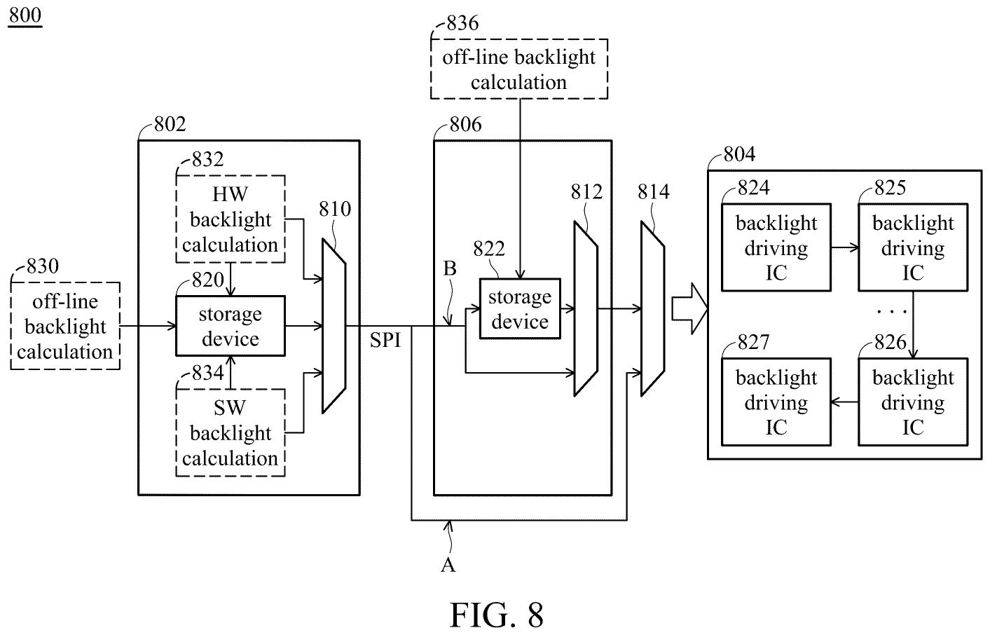

FIG. 8 is a schematic diagram of an electronic device 800 in accordance with some embodiments of the present invention. As shown in FIG. 8, the electronic device 800 includes a processor 802, a backlight driver 804, a microcontroller 806 (optional), and a multiplexer 814. In some embodiments, the electronic device 800 may be a laptop, a tablet, or a smart phone, but the present invention is not limited thereto. The processor 802 may be a system-on-chip (SoC), but the present invention is not limited thereto. In some embodiments, the processor 802 is electrically connected to the backlight driver 804 through the multiplexer 814. The processor 802 may first executes the Mboot program to enter the initialization procedure. The processor 802 receives local dimming data during the initialization procedure, and sends the local dimming data to the backlight driver during the Mboot program to enter initialization procedure. After receiving the local dimming data from the processor 802, the backlight driver 804 turns on backlights based on the local dimming data during the initialization procedure.

In detail, the processor 802 includes a storage device 820 and a multiplexer 810. In some embodiments, the processor 802 or the processor in another electronic device off-line calculates the local dimming data based on the input image used during the previous boot-up (off-line backlight calculation 830). The processor 802 then stores the local dimming data in the storage device 820 during the previous boot-up. After the electronic device is turned on again, the processor 802 reads the local dimming data from the storage device 820 during the initialization procedure. The local dimming data comprise local dimming backlight duty. The local dimming backlight duty may determine the real brightness of LEDs in each backlight partition.

In some embodiments, the processor 802 on-line calculates the local dimming data based on the input image used during the previous boot-up. In detail, the local dimming data are calculated by software or hardware configured by the processor 802 (for example, HW backlight calculation 832 and SW backlight calculation 834 in FIG. 8). In some embodiments, the Mboot program is executed to enter the initialization procedure during the previous boot-up. The local dimming data are on-line calculated based on the input image in the initialization procedure during the previous boot-up. In some embodiments, a Kernel program is executed to enter a main procedure during the previous boot-up. The local dimming data is on-line calculated based on the input image used in the main procedure during the previous boot-up. After the local dimming data is calculated, the processor 802 stores the local dimming data in the storage device 820 during the previous boot-up. The processor 802 reads the local dimming data from the storage device 820 during the initialization procedure. When the local dimming data are previously stored in the storage device 820, the multiplexer 810 sends the local dimming data stored in the storage device 820 to the multiplexer 814 through a path A in Serial Peripheral Interface (SPI) form. After that, the multiplexer 814 bypasses the local dimming data to the backlight driver 804.

In some embodiments, the local dimming data are not previously stored in the storage device 820. When the electronic device 800 is turned on, the processor 802 executes the Mboot program to enter the initialization procedure, and initializes software for local dimming during the initialization procedure. The software configured by the processor 802 calculates the local dimming data based on the input image used during the initialization procedure (SW backlight calculation 834). In some embodiments, when the electronic device 800 is turned on, the processor 802 executes the Mboot program to enter the initialization procedure, and initializes hardware for local dimming during the initialization procedure. The hardware configured by the processor 802 calculates the local dimming data based on the input image used during the initialization procedure (HW backlight calculation 832). When the local dimming data are not previously stored in the storage device 820, the multiplexer 810 receives the local dimming data from functions of HW backlight calculation 832 and SW backlight calculation 834. The multiplexer 810 then sends the local dimming data to the multiplexer 814 through the path A in SPI form. After that, the multiplexer 814 bypasses the local dimming data to the backlight driver 804.

The microcontroller 806 includes a multiplexer 812 and a storage device 822. In some embodiments, when the microcontroller 806 is present, the multiplexer 810 sends the local dimming data to the microcontroller 806 through a path B. In detail, the microcontroller 806 may store the local dimming data in the storage device 822 or bypass the local dimming data to the multiplexer 812. The local dimming data received from the multiplexer 810 may come from the storage device 820 and the functions of HW backlight calculation 832 and SW backlight calculation 834. In some embodiments, the microcontroller 806 or the processor in another electronic device off-line calculates the local dimming data based on the input image used during the previous boot-up (off-line backlight calculation 836). The microcontroller 806 then stores the local dimming data in the storage device 822 during the previous boot-up. After the electronic device is turned on again, the microcontroller 806 reads the local dimming data from the storage device 822 during the initialization procedure.

In some embodiments, when the electronic device 800 is turned on, the processor 802 may first be initialized. Then, the processor 802 detects whether there is the microcontroller 806 connected to itself. If yes, the processor 802 wakes up the microcontroller 806 for initialization. After waiting the initialization of the microcontroller 806, the processor 802 sends the local dimming duty included in the local dimming data to the backlight driver 804. The backlight driver 804 turns on backlights based on the local dimming duty during the initialization procedure.

The backlight driver 804 includes a plurality of backlight driving integrated circuits (ICs), such as a backlight driving IC 824, a backlight driving IC 825, a backlight driving IC 826, and a backlight driving IC 827, but the present invention is not limited thereto. In some embodiments, the number of backlight driving ICs is equal to the number of backlight partitions. For example, in FIG. 8, the backlight driving IC 824, the backlight driving IC 825, the backlight driving IC 826, and the backlight driving IC 827 may correspond to four backlight partitions on a display (not shown). The backlight driving IC 824, the backlight driving IC 825, the backlight driving IC 826, and the backlight driving IC 827 turns on backlights in respective backlight partitions based on the local dimming duty during the initialization procedure.

The method and electronic device 800 for applying local dimming on a boot display is proposed to change from global backlight initialization to local dimming backlight initialization. From boot logo to normal screen display, local dimming backlights play a role in the entire process. The method and electronic device 800 for applying local dimming on a boot display show the effect of local dimming during the executing the Mboot program, which is executed earlier than the Kernel program to enter a main procedure. The local dimming can be realized in advance. The method and electronic device 800 for applying local dimming on a boot display only need to modify the software logic without changing the hardware, so it is relatively easy to implement. The method and electronic device 800 for applying local dimming on a boot display can improve the competitiveness of customer products from the product perspective and has great promotion value.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for applying local dimming on a boot display, comprising:
receiving local dimming data during an initialization procedure;
sending the local dimming data to a backlight driver during an Mboot program to enter the initialization procedure; and
turning on backlights based on the local dimming data during the initialization procedure.

2. The method as claimed in claim 1, wherein the local dimming data is read from a storage device or calculated based on an input image.

3. The method as claimed in claim 1, wherein the local dimming data comprise local dimming backlight duty.

4. The method as claimed in claim 1, wherein the step of receiving local dimming data during the initialization procedure comprises:
off-line calculating the local dimming data based on an input image during a previous boot-up;
storing the local dimming data in a storage device during the previous boot-up; and
reading the local dimming data from the storage device during the initialization procedure.

5. The method as claimed in claim 1, wherein the step of receiving local dimming data during the initialization procedure comprises:
on-line calculating the local dimming data based on an input image during the previous boot-up;
storing the local dimming data in a storage device during the previous boot-up; and
reading the local dimming data from the storage device during the initialization procedure.

6. The method as claimed in claim 5, wherein the step of on-line calculating the local dimming data based on the input image during the previous boot-up is executed by software or hardware.

7. The method as claimed in claim 1, wherein the step of receiving local dimming data during the initialization procedure comprises:
initializing software for local dimming during the initialization procedure; and
calculating the local dimming data based on an input image by the software during the initialization procedure.

8. The method as claimed in claim 1, wherein the step of receiving local dimming data during the initialization procedure comprises:
initializing hardware for local dimming during the initialization procedure; and
calculating the local dimming data based on an input image by the hardware during the initialization procedure.

9. The method as claimed in claim 6, wherein the step of on-line calculating the local dimming data based on the input image during the previous boot-up, comprises:
executing an Mboot program to enter the initialization procedure during the previous boot-up; and
on-line calculating the local dimming data based on the input image in the initialization procedure during the previous boot-up.

10. The method as claimed in claim 6, wherein the step of on-line calculating the local dimming data based on the input image during the previous boot-up, comprises:
executing a Kernel program to enter a main procedure during the previous boot-up; and
on-line calculating the local dimming data based on the input image in the main procedure during the previous boot-up.

11. An electronic device to apply local dimming on a boot display, comprising:
a backlight driver;
a processor, electrically connected to the backlight driver, configured to receive local dimming data during the initialization procedure, and to send the local dimming data to the backlight driver during an Mboot program to enter the initialization procedure;
wherein the backlight driver is configured to turn on backlights based on the local dimming data during the initialization procedure.

12. The electronic device as claimed in claim 11, further comprising:
a microcontroller, electrically connected between the backlight driver and the processor, configured to receive the local dimming data during the initialization procedure, and to send the local dimming data to the backlight driver during the Mboot program to enter the initialization procedure.

13. The electronic device as claimed in claim 11, wherein the local dimming data is read from a storage device or calculated based on an input image.

14. The electronic device as claimed in claim 11, wherein the local dimming data comprise local dimming backlight duty.

15. The electronic device as claimed in claim 11, wherein
the processor off-line calculates the local dimming data based on an input image during the previous boot-up;
the processor stores the local dimming data in a storage device during the previous boot-up; and
the processor reads the local dimming data from the storage device during the initialization procedure.

16. The electronic device as claimed in claim 11, wherein
the processor on-line calculates the local dimming data based on an input image during the previous boot-up;
the processor stores the local dimming data in a storage device during the previous boot-up; and
the processor reads the local dimming data from the storage device during the initialization procedure.

17. The electronic device as claimed in claim 16, wherein the local dimming data are calculated by software or hardware configured by the processor.

18. The electronic device as claimed in claim 11, wherein
the software for local dimming is initialized during the initialization procedure; and
the local dimming data are calculated based on an input image by the software during the initialization procedure.

19. The electronic device as claimed in claim 11, wherein
the hardware for local dimming is initialized during the initialization procedure; and
the local dimming data are calculated based on an input image by the hardware during the initialization procedure.

20. The electronic device as claimed in claim 16, wherein
the processor executes an Mboot program to enter the initialization procedure during the previous boot-up; and
the processor on-line calculates the local dimming data based on the input image in the initialization procedure during the previous boot-up.

21. The electronic device as claimed in claim 16, wherein
the processor executes a Kernel program to enter a main procedure during the previous boot-up; and
the processor on-line calculates the local dimming data based on the input image in the main procedure during the previous boot-up.

22. The electronic device as claimed in claim 11, wherein the backlight driver comprises a plurality of backlight driving integrated circuits (ICs); wherein the number of backlight driving ICs is equal to the number of backlight partitions.
